(19) United States
(12) Patent Application Publication
(10) Pub. No.: US 2017/0293609 A1
(43) Pub. Date: Oct. 12, 2017

(54) METHODS AND SYSTEMS USING COGNITIVE ARTIFICAL INTELLIGENCE TO IMPLEMENT ADAPTIVE LINGUISTIC MODELS TO PROCESS DATA

(71) Applicants: Tao YANG, (US); Gang XU, (US); Wesley Kenneth COBB, (US); Omni AI, Inc., Dallas, TX (US)

(72) Inventors: Ming-Jung SEOW, Richmond, TX (US); Tao YANG, Katy, TX (US); Gang XU, Katy, TX (US); Wesley Kenneth COBB, The Woodlands, TX (US)

(21) Appl. No.: 15/481,302

(22) Filed: Apr. 6, 2017

Related U.S. Application Data
(60) Provisional application No. 62/318,999, filed on Apr. 6, 2016.
(60) Provisional application No. 62/319,170, filed on Apr. 6, 2016.

(51) Int. Cl. G06F 17/27; G06N 99/00; G06N 5/04

(52) U.S. Cl. CPC G06F 17/2785; G06N 5/04; G06N 99/005; G06F 17/271; G06F 17/277

(57) ABSTRACT

Techniques are disclosed for analyzing and learning behaviors based on acquired sensor data. A neuro-linguistic cognitive engine performs learning and analysis on linguistic content (e.g., identified alpha symbols, betas, and gammas) obtained by a linguistic model that clusters observations to generate the linguistic content. The neuro-linguistic cognitive engine compares new data to learned patterns stored in short and longer-term memories and determines whether to issue special event notifications indicating anomalous behavior. In one embodiment, condition(s) may be generated for new data and checked against inference nodes of an inference network. Inference nodes matching the condition(s) are executed to, e.g., compare the new data with the learned patterns, with output from the inference nodes being used to generate additional condition(s) that are again matched to inference nodes which may be executed.

### CROSS-REFERENCE TO RELATED APPLICATIONS

This application claims the priority benefit of U.S. Application No. 62/318,999, entitled “Neuro-Linguistic Cognitive Engine,” filed on Apr. 6, 2016, and U.S. Application No. 62/319,170, entitled “Optimized Selection of Data Features for a Neuro-Linguistic System,” filed on Apr. 6, 2016, each of which is incorporated herein by reference in its entirety.

### TECHNICAL FIELD

Embodiments described herein generally relate to methods and systems using cognitive artificial intelligence to implement adaptive linguistic models to process data.

### BACKGROUND

Many currently available surveillance and monitoring systems (e.g., video surveillance systems, SCADA systems, data network security systems, and the like) are trained to observe specific activities and alert an administrator after detecting those activities.

However, such known rules-based systems require advance knowledge of what actions and/or objects to observe. The activities may be hard-coded into underlying applications or the system may train itself based on any provided definitions or rules. Unless the underlying code includes descriptions of certain rules, activities, behaviors, or cognitive response for generating a special event notification for a given observation, the system is incapable of recognizing it. A rules only based approach is too rigid. That is, unless a given behavior conforms to a predefined rule, an occurrence of the behavior can go undetected by the monitoring system. Even if the system trains itself to identify the behavior, the system requires rules to be defined in advance for what to identify.

In addition, many surveillance systems, e.g., video surveillance systems, typically require a significant amount of computing resources, including processor power, storage, and bandwidth. For example, typical video surveillance systems require a large amount of computing resources per camera feed because of the typical size of video data. Given the cost of the resources, such surveillance systems are difficult to scale.

### SUMMARY

One embodiment provides a computer-implemented method to implement an adaptive linguistic model for processing data. The method generally includes generating a representation of at least one condition based on output data that is generated by the adaptive linguistic model. The method further includes determining whether the at least one condition triggers execution of at least one node in a plurality of nodes. Each node from the plurality of nodes represent a subtask of at least one task in a plurality of tasks. Each task in the plurality of tasks includes a plurality of subtasks in an order. In addition, the method includes for each node in the plurality of nodes whose execution is triggered, iteratively performing the following: executing that node including performing the subtask represented by that node and determining if executing that node generates an output. If executing that node does generate an output, the method includes updating the adaptive linguistic model based on the output, generating at least one additional condition based on the output, and determining whether the at least one additional condition triggers execution of at least a second node in the plurality of nodes.

In some instances, executing the first node includes loading the adaptive linguistic model and comparing data input into the subtask that is represented by the first node against the adaptive linguistic model loaded from the memory to determine a score indicating unusualness of the data input into the subtask that is represented by the first node. In some embodiments, executing the first node further includes retrieving the data input into the subtask represented by the first node from the memory and storing the score in the memory. The at least one additional condition is generated responsive to the storing of the score in the memory.

In some instances, the adaptive linguistic model is a first adaptive linguistic model and the memory is at least one of: a first memory that is configured to store a second adaptive linguistic model such that the second adaptive linguistic model is an updated version of the first adaptive linguistic model or a second memory that is configured to store a third adaptive linguistic model such that the third adaptive linguistic model is the first adaptive linguistic model that has reached a statistical significance threshold. In some instances, the first memory includes a hierarchical data structure mapping keys to values and the second memory is an episodic memory that includes a sparse distributed memory. In some instances, the adaptive linguistic model attaining statistical confidence threshold from the second memory is further persisted in a third memory that stores generalizations and representations of data with episodic details removed.

In some instances, the adaptive linguistic model is at least one of: a model used to identify feature symbols, feature words and feature syntax from data; a model used to determine anomalies; a model used to determine unusual lexicon; a model used to determine unusual feature syntax; a model used to determine unusual trajectories; or a model used to determine unusual trends over time.

In some instances, in response to determining that the at least one condition or the at least one additional condition triggers execution of at least one node from the plurality of nodes, the method further includes placing the subtask represented by the at least one node in a priority queue for execution. A priority of subtasks in the priority queue is increased over time as the subtasks remain in the priority queue.

In some instances, the at least one condition and the at least one additional condition include a requirement for sufficient data and resources for computation of subtasks. Executing at least two nodes in the plurality of nodes includes performing the corresponding subtasks representing the at least two nodes asynchronously and in parallel. In some instances, the plurality of tasks can include a task configured to determine configurations of features that each sensor of a plurality of sensors can contribute to a single combined sensor based on learned behaviors of and relationships between the plurality of sensors. Each task in the plurality of tasks represents at least one of anomaly detection or filtering alerts. The plurality of nodes are configurable and programmable.

Other embodiments include a computer-readable medium that includes instructions that enable a processing unit to implement one or more embodiments of the disclosed method as well as a system configured to implement one or more embodiments of the disclosed method.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, processes, and features will become apparent upon examination of the following drawings and detailed description. It is intended that all such additional systems, processes, and features be included within this description, be within the scope of the present disclosure, and be protected by the accompanying claims.

### BRIEF DESCRIPTION OF THE DRAWINGS

The drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

So that the manner in which the above recited features, advantages, and objects of the present disclosure are attained and can be understood in detail, a more particular description of the disclosure, briefly summarized above, may be had by reference to the embodiments illustrated in the appended drawings.

It is to be noted, however, that the appended drawings illustrate only typical embodiments and are therefore not to be considered limiting of the scope of the disclosure, for the disclosure may admit to other equally effective embodiments.

FIG. 1 illustrates components of a neuro-linguistic cognitive AI system, according an embodiment.

FIG. 2 further illustrates components of the neuro-linguistic cognitive AI system shown in FIG. 1, according to an embodiment.

FIG. 3 illustrates a cognitive process, according to an embodiment.

FIG. 4 illustrates an inference network architecture according to an embodiment.

FIG. 5 illustrates components of a short-term memory, according to an embodiment.

FIG. 6 illustrate example nodes in an inference network, according to an embodiment.

FIG. 7 illustrates an example task being processed using an inference network, according to an embodiment.

FIG. 8 illustrates a method for processing data in a neuro-linguistic cognitive engine, according to an embodiment.

FIG. 9 illustrates a method for cognitive analytics in a neuro-linguistic cognitive engine, according to an embodiment.

### DETAILED DESCRIPTION

Embodiments described herein provide a method and a system for analyzing and learning behavior based on acquired sensor data. A machine learning engine may engage in an undirected and unsupervised learning approach to learn patterns regarding behaviors observed via the sensors. Thereafter, when unexpected (i.e., abnormal or unusual) behaviors are observed, special event notifications may be generated.

In one embodiment, a neuro-linguistic cognitive engine performs learning and analysis on linguistic content (e.g., identified grouped set of symbols) output by a linguistic model that builds an adaptive feature language (AFL) based on this set of symbols dynamically generated from input sensor data. The input data is used to discover base feature symbols which are designated as Alpha symbols (alphas). Combinations of one or more Alpha symbols are designated as betas or feature words. Combinations of one or more betas are designated as gammas or feature syntax. The cognitive engine may compare new data, such as scores measuring unusualness of an alpha symbol, beta, or gamma that are output by the linguistic model, to learned patterns stored in a memory, and estimate the unusualness of the new data. In particular, condition(s) may be generated for new data and checked against inference nodes of an inference network. Inference nodes matching the condition(s) are then executed to, e.g., compare the new data with the learned patterns, with output from the inference nodes being used to generate additional condition(s) that are again matched to inference nodes which may be executed. This process may repeat, until the data output by the inference nodes do not produce condition(s) that trigger further inference nodes to run, or final inference nodes of task(s) (e.g., an inference node that publishes an anomaly special event notification) are reached.

In the following, reference is made to embodiments of the invention. However, it should be understood that the invention is not limited to any specifically described embodiment. Instead, any combination of the following features and elements, whether related to different embodiments or not, is contemplated. Furthermore, in various embodiments provides numerous advantages over the prior art. However, although embodiments may achieve advantages over other possible solutions and/or over the prior art, whether or not a particular advantage is achieved by a given embodiment is not limiting. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment is implemented as a program product for use with a computer system. The program(s) of the program product defines functions of the embodiments (including the methods described herein) and can be contained on a variety of computer-readable storage media. Examples of computer-readable storage media include (i) non-writable storage media (e.g., read-only memory devices within a computer such as CD-ROM or DVD-ROM disks readable by an optical media drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other examples media include communications media through which information is conveyed to a computer, such as through a computer or telephone network, including wireless communications networks.

In general, the routines executed to implement the embodiments may be part of an operating system or a specific application, component, program, module, object, or sequence of instructions. The computer program of an embodiment(s) is comprised typically of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment. However, it should be appreciated that any particular program nomenclature that follows is used merely for convenience, and thus the embodiments should not be limited to use solely in any specific application identified and/or implied by such nomenclature.

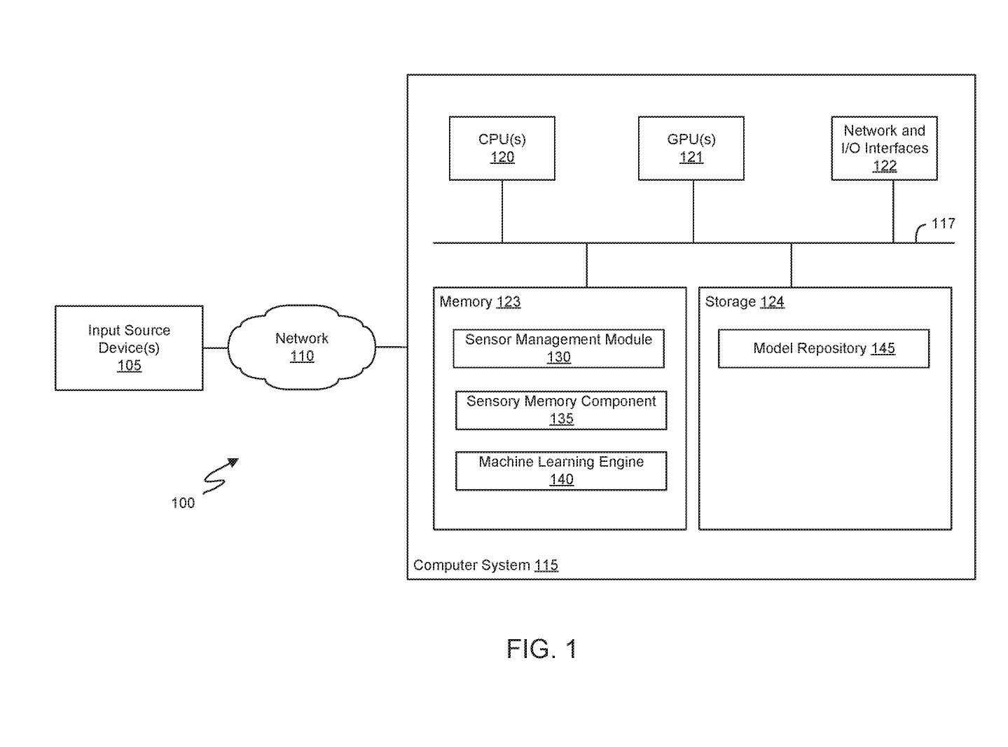

FIG. 1 illustrates components of a neuro-linguistic cognitive AI system 100, according to an embodiment. As shown, the Cognitive AI System 100 includes one or more input source devices 105 (e.g., sensor devices), a network 110, and one or more computer systems 115. The network 110 may transmit data input by the input source devices 105 to the computer system 115. Generally, the computing environment 100 may include one or more physical computer systems 115 connected via a network (e.g., the Internet, wireless networks, local area networks). Alternatively, the computer systems 115 may be cloud computing resources connected by the network 110. Illustratively, the computer system 115 includes one or more central processing units (CPU) 120, one or more graphics processing units (GPU) 121, network and I/O interfaces 122, a storage 124 (e.g., a disk drive, optical disk drive, and the like), and a memory 123 that includes a sensor management module 130, a sensory memory component 135, and a machine learning engine 140. The memory 123 may comprise one or more memory devices, such as system memory and graphics memory. The memory 123 is generally included to be representative of a random access memory (e.g., DRAM, SRAM, SDRAM). The memory 123 and storage 124 may be coupled to the CPU 120, GPU 121, and network and I/O interfaces 122 across one or more buses 117. The storage 124 includes a model repository 145. Additionally, storage 124, may generally include one or more devices such as a hard disk drive, solid state device (SSD), or flash memory storage drive, and may store non-volatile data as required.

The CPU 120 retrieves and executes programming instructions stored in the memory 123 as well as stores and retrieves application data residing in the storage 124. In some embodiments, the GPU 121 implements a Compute Unified Device Architecture (CUDA). Further, the GPU 121 is configured to provide general purpose processing using the parallel throughput architecture of the GPU 121 to more efficiently retrieve and execute programming instructions stored in the memory 123 and also to store and retrieve application data residing in the storage 124. The parallel throughput architecture provides thousands of cores for processing the application and input data. As a result, the GPU 121 leverages the thousands of cores to perform read and write operations in a massively parallel fashion. Taking advantage of the parallel computing elements of the GPU 121 allows the cognitive AI system 100 to better process large amounts of incoming data (e.g., input from a video and/or audio source). As a result, the cognitive AI system 100 may scale with relatively less difficulty.

The sensor management module 130 provides one or more data collector components. Each of the collector components is associated with a particular input source device, e.g., a video source, a SCADA (supervisory control and data acquisition) source, an audio source, a network traffic source, etc. The collector components retrieve (or receive, depending on the sensor) input data from each source at specified intervals. The sensor management module 130 controls the communications between the data sources. Further, the sensor management module 130 normalizes input data and sends the normalized data to the sensory memory component 135. The normalized data may be packaged as a sample vector, which includes information such as feature values, type of input source devices 105, and an id associated with the input source devices 105. In some embodiments, the data collector components collect raw data values from different input source devices (e.g., video data, building management data, SCADA data). The data collector components may retrieve video frames in real-time, separate foreground objects from background objects, and track foreground objects from frame-to-frame. The sensor management module 130 may normalize objects identified in the video frame data into numerical values (e.g., falling within a range from 0 to 1 with respect to a given data type).

The sensory memory component 135 is a data store that transfers large volumes of data from the sensor management module 130 to the machine learning engine 140. The sensory memory component 135 stores the data as records. Each record may include an identifier, a timestamp, and a data payload. Further, the sensory memory component 135 aggregates incoming data in a time-sorted fashion. Storing incoming data from each of the data collector components in a single location where the data may be aggregated allows the machine learning engine 140 to process the data efficiently. Further, the computer system 115 may reference data stored in the sensory memory component 135 in generating special event notifications for anomalous activity. In some embodiments, the sensory memory component 135 may be implemented via a virtual memory file system in the memory 123. In another embodiment, the sensory memory component 135 is implemented using a key-value store.

The machine learning engine 140 (also referred as “neuro-linguistic cognitive engine”) receives data output from the sensor management module 135. Generally, components of the machine learning engine 140 generate a linguistic representation of the normalized vectors. As described further below, to do so, the machine learning engine 140 tokenizes and/or clusters normalized values having a set of similar characteristics or features and assigns a distinct feature symbol (e.g., alpha symbol) to each cluster. The machine learning engine 140 may then identify recurring combinations of feature symbols (e.g, alpha symbols) i.e., betas in the data. The machine learning engine 140 then similarly identifies recurring combinations of betas (i.e., gammas) in the data. In addition, a cognitive computational engine in the machine learning engine 140 builds models for understanding the alpha symbols, betas, and gammas; updates and tracks changes in the models; makes inferences based on the models; and performs actions based on the inferences, as discussed in greater detail below.

Note, however, FIG. 1 illustrates merely one possible arrangement of the cognitive AI system 100. For example, although the input sources devices 105 (e.g., sensor devices) are shown connected to the computer system 115 via network 110, the network 110 is not always present or needed (e.g., an input source such as a video camera may be directly connected to the computer system 115).

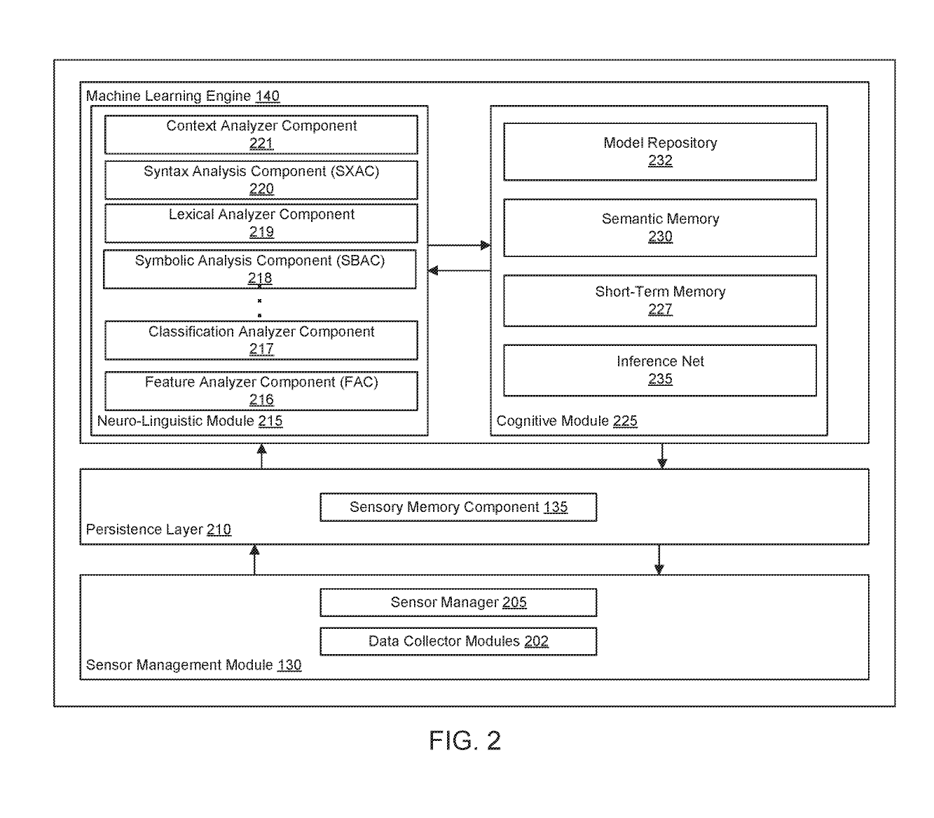

FIG. 2 further illustrates components of the neuro-linguistic cognitive AI system shown in FIG. 1, according to an embodiment. As shown, the machine learning engine 140 includes a neuro-linguistic module 215 and a cognitive module 225. The neuro-linguistic module 215 performs neural network-based linguistic analysis of normalized input data to build a neuro-linguistic model representation of the observed input data. Rather than describing observed activity based on pre-defined objects and actions, the neuro-linguistic module 215 develops an adaptive feature language based on alpha symbols, betas, and gammas generated from the input data. The neuro-linguistic model includes feature symbols that serve as building blocks for the feature syntax. Feature symbols associated with base features in the data are called alphas. Collections of one or more alphas are called betas or feature words. Collections of betas are called gammas or feature syntax. As shown, the neuro-linguistic module 215 includes a feature analysis component 216, a classification analyzer component 217, a symbolic analysis component (SBAC) 218, a lexical analyzer component 219, and a feature syntax analysis component (SXAC) component 220.

Additionally, in some embodiments, the neuro-linguistic module 215 may also include additional modules, such as a trajectory module, for observing and describing various activities.

In one embodiment, the Feature Analysis Component (FAC) 216 retrieves the normalized vectors of input data from the sensory memory component 135 and stages the input data in the pipeline architecture provided by the GPU 121. The classification analyzer component 217 evaluates the normalized data organized by the FAC component 216 and maps the data on a neural network. In one embodiment, the neural network may be a combination of a self-organizing map (SOM) and an adaptive resonance theory (ART) network.

The symbolic analysis component 218 clusters the data streams based on values occurring repeatedly in association with one another. Further, the symbolic analysis component 218 generates a set of probabilistic clusters for each input feature. For example, assuming that the input data corresponds to video data, features may include location, velocity, acceleration etc. The symbolic analysis component 218 may generate separate sets of probabilistic clusters for each of these features. Feature symbols (e.g., alpha symbols) are generated that correspond to each statistically relevant probabilistic cluster. The symbolic analysis component 218 learns alpha symbols (i.e., builds an alphabet of alphas) based on the probabilistic clustered input data. That is, the symbolic analysis component 218 generates a set of probabilistic clusters for each input feature. These clusters are tokenized into feature symbols (e.g., alphas). Thus, the symbolic analysis component 218 builds alphabet of alphas based on the probabilistic clustered input data. In one embodiment, the symbolic analysis component 218 may determine a statistical distribution (e.g., mean, variance, and standard deviation) of data in each probabilistic cluster and update the probabilistic clusters as more data is received. The symbolic analysis component 218 may further assign a set of alpha symbols to probabilistic clusters having statistical significance. Each probabilistic cluster may be associated with a statistical significance score that increases as more data that maps to the probabilistic cluster is received. The symbolic analysis component 218 may assign alpha symbols to probabilistic clusters whose statistical significance score exceeds a threshold. In some instances, each probabilistic cluster may have a collection of observations and the threshold may be a number relating to such observations. In addition, the symbolic analysis component 218 may decay the statistical significance of a probabilistic cluster as the symbolic analysis component 218 observes data mapping to the probabilistic cluster less often over time. The symbolic analysis component 218 “learns on-line” and may identify new alpha symbols as new probabilistic clusters reach statistical significance and/or merge similar observations to a more generalized cluster which is then assigned a new alpha symbol. An alpha symbol may generally be described as a letter of an alphabet used to create betas used in the neuro-linguistic analysis of the input data. That is, a set of alphas may describe an alphabet. Alpha(s) can be used to create beta(s) and may be generally described as building blocks of beta(s). An alpha symbol provides a “fuzzy” representation of the data belonging to a given probabilistic cluster.

In one embodiment, the symbolic analysis component 218 may also evaluate an unusualness score for each alpha symbol that is assigned to a probabilistic cluster. The unusualness score may be based on the frequency of a given alpha symbol relative to other alpha symbols observed in the input data stream, over time. In some embodiments, the unusualness score indicates how infrequently a given alpha symbol has occurred relative to past observations. The unusualness score may increase or decrease over time as the neuro-linguistic module 215 receives additional data.

Once a probabilistic cluster has reached statistical significance, the symbolic analysis component 218 sends corresponding alpha symbols to the lexical analyzer component 219 in response to data that maps to that probabilistic cluster. Said another way, once alpha symbol(s) are mapped to a probabilistic cluster that has reached statistical significance, the symbolic analysis component 218 sends the corresponding alpha symbol(s) to the lexical analyzer component 219. In some instances, if a probabilistic cluster does not reach statistical significance the symbolic analysis component 218 may send an unknown symbol to the lexical analyzer component 219. In some embodiments, the symbolic analysis component 218 limits alpha symbols that can be sent to the lexical component 219 to the most statistically significant probabilistic clusters. Note, over time, the most frequently observed alpha symbols may change as probabilistic clusters increase (or decrease) in statistical significance. As such, it is possible for a given probabilistic cluster to lose statistical significance. Over time, thresholds for statistical significance can also increase, and thus, if the amount of observed data mapping to a given probabilistic cluster fails to meet a threshold, then the probabilistic cluster loses statistical significance.

Given the stream of the alpha symbols (e.g., base symbols) and other data such as timestamp data, unusualness scores, and statistical data (e.g., a representation of the probabilistic cluster associated with a given alpha symbol) received from the symbolic analysis component 218, the lexical analyzer component 219 builds a dictionary that includes combinations of co-occurring alpha symbols, e.g., betas, from the alpha symbols transmitted by the symbolic analysis component 218. That is, the lexical analyzer component 219 identifies repeating co-occurrences of alphas and features output from the symbolic analysis component 218 and calculates frequencies of the co-occurrences occurring throughout the alpha symbol stream. The combinations of alpha symbols may represent a particular activity, event, etc. In some embodiments, the lexical analyzer component 219 may limit the length of betas in the dictionary to allow the lexical analyzer component 219 to identify a number of possible combinations without adversely affecting the performance of the computer system 115. In practice, limiting a beta to a maximum of five or six alpha symbols has shown to be effective. Further, the lexical analyzer component 219 may use level-based learning models to analyze alpha symbol combinations and learn betas. The lexical analyzer component 219 may learn betas, up through the maximum alpha symbol combination length, at incremental levels, i.e., where one-alpha betas are learned at a first level, two-alpha betas are learned at a second level, and so on.

Like the symbolic analysis component 218, the lexical analyzer component 219 is adaptive. That is, the lexical analyzer component 219 may learn and generate betas in the dictionary over time. The lexical analyzer component 219 may also reinforce or decay the statistical significance of betas in the dictionary as the lexical analyzer component 219 receives subsequent streams of alpha symbols over time. Further, the lexical analyzer component 219 may determine an unusualness score for each beta based on how frequently the beta recurs in the data. The unusualness score may increase or decrease over time as the neuro-linguistic module 215 processes additional data. In some embodiments, the unusualness score indicates how infrequently a particular beta has occurred relative to past observations.

In addition, as observations (i.e., alpha symbols) are passed to the lexical analyzer component 219 and identified as a being part of a given beta, the lexical analyzer component 219 may eventually determine that the beta model has matured. Once a beta model has matured, the lexical analyzer component 219 may output observations of those betas in the model to the SXAC component 219. In some embodiments, the lexical analyzer component 219 limits betas sent to the SXAC component 320 to the most statistically relevant betas. In practice, for each single sample, outputting occurrences of the top thirty-two most statistically relevant betas has shown to be effective (while the most frequently occurring betas stored in the models can amount to thousands of betas). Note, over time, the most frequently observed betas may change as the observations of incoming alphas change in frequency (or as new alphas emerge by the clustering of input data by the symbolic analysis component 218.

The SXAC component 220 builds a feature syntax of gammas from the betas output by the lexical analyzer component 219 on the sequence of betas output from the lexical analyzer component 219. In one embodiment, the SXAC component 220 receives the betas identified by the lexical analyzer component 219 and generates a connected graph, where the nodes of the graph represent the betas, and the edges represent a relationship between the betas. The SXAC component 220 may reinforce or decay the links based on the frequency that the betas are connected with one another in a data stream. Thus, the SXAC component 220 can build an un-directed graph, i.e., feature syntax of gammas, based on co-occurrences of betas. In some embodiments, the SXAC component 220 may use a non-graph based approach to build gammas by stacking betas one after another to construct a layer. Similar to the symbolic analysis component 218 and the lexical analyzer component 219, the SXAC component 220 may also determine an unusualness score for each identified gamma based on how frequently the gamma recurs in the linguistic data. The unusualness score may increase or decrease over time as the neuro-linguistic module 215 processes additional data. Similar to the lexical analyzer component 219, the SXAC component 220 may also limit the length of a given gamma to allow the SXAC component 220 to be able to identify a number of possible combinations without adversely affecting the performance of the computer system 115.

As discussed, the SXAC component 220 identifies feature syntax gammas over observations of betas output from the lexical analyzer component 219. As observations of betas accumulate, the SXAC component 220 may determine that a given gamma has matured, i.e., a gamma has reached a measure of statistical relevance. The SXAC component 220 then outputs observations of that gamma to the cognitive module 325. The SXAC component 220 sends data that includes a stream of the alpha symbols, betas, gammas, timestamp data, unusualness scores, and statistical calculations to the cognitive module 325. That is, after maturing, the alphas, betas, and gammas generated by the neuro-linguistic module 215 form a semantic memory of the input data that the computer system 115 uses to compare subsequent observations of alphas, betas, and gammas against the stable model. The neuro-linguistic module 215 may update the linguistic model as new data is received. Further, when the neuro-linguistic module 215 receives subsequently normalized data, the module 215 can output an ordered stream of alpha symbols, betas, and gammas, all of which can be compared to the Semantic Memory that has been generated to identify interesting patterns or detect deviations occurring in the stream of input data.

The context analyzer component 221 builds a higher order feature context from collections of gamma elements received from the syntax analyzer component. In one embodiment, analyzing trajectory is one of the core functions of the context analyzer component. Analyzing trajectory includes learning and/or inferring based on a time sequence of alphas, betas, or gammas. This builds a higher level of models by incorporating the temporal patterns and dependency among features or combination of features. A non-limiting example of trajectory analysis includes observing a video scene including cars and people. In particular, observing various tracks of cars and tracks of people in the video scene to identify clustering patterns of these tracks.

Thus, the neuro-linguistic module 215 generates a lexicon, i.e., builds a feature dictionary, of observed combinations of feature symbols/alphas (i.e., feature words/betas), based on a statistical distribution of feature symbols identified in the input data. Specifically, the neuro-linguistic module 215 may identify patterns of feature symbols associated with the input data at different frequencies of occurrence. Further, the neuro-linguistic module 215 can identify statistically relevant combinations of feature symbols at varying lengths (e.g., from one-symbol to collections of multiple symbol feature word length). The neuro-linguistic module 215 may include such statistically relevant combinations of feature symbols in a feature dictionary used to identify feature syntax.

The cognitive module 225 performs learning and analysis on the linguistic content (i.e., the identified alpha symbols, betas, gammas) produced by the neuro-linguistic module 215 by comparing new data to learned patterns in the models kept in memory and then estimating the unusualness of the new data. As shown, the cognitive module 225 includes a short-term memory 227, a semantic memory 230, a model repository 232, and an inference network 235. The semantic memory 230 stores the stable neuro-linguistic model generated by the neuro-linguistic module 215, i.e., stable copies from the symbolic analysis component 218, lexical analyzer component 219, and the SXAC component 220. The inference network 235 may compare the stored copies of the models with each other and with the current models to detect changes over time, as well as create, use, and update current and stored models in the short-term memory 227, semantic memory 230, and model repository 232 to generate special event notifications when unusual or anomalous behavior is observed, as discussed in greater detail below.

In one embodiment, the short-term memory 227 may be implemented in GPU(s) 121 (e.g., in CUDA), and the short-term memory 227 may be a hierarchical key-value data store. In contrast, the semantic memory 230 may be implemented in computer memory 123 and include a sparse distributed memory for storing models attaining statistical confidence thresholds from the short-term memory 227. The model repository 232 is a longer-term data store that stores models attaining statistical confidence thresholds from the semantic memory 230, and the model repository 232 may be implemented in the computer storage 124 (e.g., a disk drive or a solid-state device). It should be understood that models stored in the semantic memory 230 and the model repository 232 may be generalizations including encoded data that is more compact than raw observational data. For example, the semantic memory 230 may be an episodic memory that stores linguistic observations related to a particular episode in the immediate past and encodes specific details, such as the “what” and the “when” of a particular event. The model repository 232 may instead store generalizations of the linguistic data with particular episodic details stripped away.

In another embodiment, a database (e.g., a Mongo database) distinct from the model repository 232 may also be used to store copies of models attaining statistical confidence thresholds. In yet another embodiment, the inference network 235 may have direct access to only the short-term memory 227, and data that is needed from longer-term memories such as the semantic memory 230 may be copied to the short-term memory 227 for use by the inference network 235.

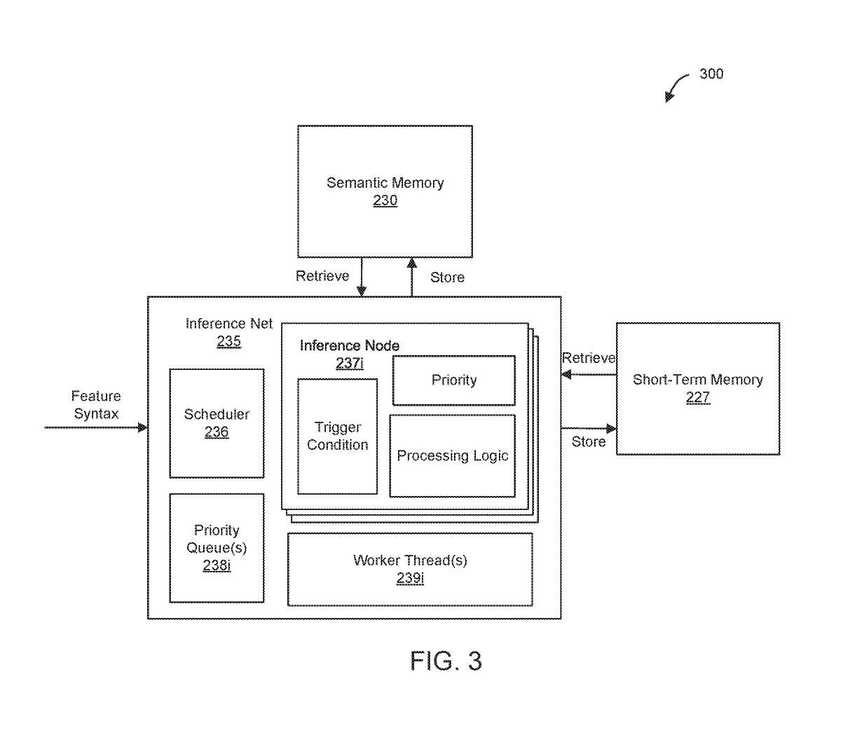

FIG. 3 illustrates a cognitive process 300, according to an embodiment. As shown, the cognitive process 300 begins when a feature syntax is received from the neuro-linguistic module 215 by the cognitive module 225. In one embodiment, the feature syntax may include one or more of the unusualness scores generated by the symbolic analysis component 218, the lexical analyzer component 219, the syntax analyzer component 220 and the context analyzer component 221; trajectories of objects observed in video data streams (e.g., tracks of car, people, etc.); and special event notification directives specifying particular behaviors that should trigger a special event notification among other things. Such output from the neuro-linguistic module 215 is not used directly, but is rather passed to the cognitive module 225 for further learning and analysis to produce anomaly special event notifications, as discussed in greater detail below.

As shown, the cognitive module 215 includes an inference network 235 that is configured to retrieve data for processing from the short-term memory 227 or from the semantic memory 230. Models that are up-to-date and continuously updated may be stored in the short-term memory 227. The previous states of such up-to-date models may be lost, however, whenever the models are updated. To save such previously states, the models with statistical significance may be periodically persisted to the semantic memory 230, which as discussed is a longer-term data store for storing models attaining statistical confidence thresholds, with potentially some generalizations. The up-to-date models and models attaining statistical confidence thresholds may be retrieved from the short-term memory 227 and the semantic memory 230, respectively, to make inferences (e.g., inferring whether a feature syntax received from the neuro-linguistic module 215 is unusual) and perform actions (e.g., generating an special event notification) based on the inferences.

As discussed in greater detail below, the inference net 235 includes a scheduler 236 and multiple inference nodes 237i that are triggered to run based on predefined criteria. The cognitive module 215 is akin to a computer operating system, and the inference nodes are akin to programs that run in the operating system while retrieving data from and storing data to memories, disk drives, etc. Feature Syntaxes received from the neuro-linguistic module 215 may initially be stored in the short-term memory 227, and the short-term memory 227 may generate condition(s) and/or a representation of condition(s) based on the received feature syntaxes that are then checked against each inference node 237i of the inference net 235. Inference nodes matching the condition(s) may be placed by a scheduler into the priority queues 238, and the scheduler may further pass those inference nodes to the work threads 239 for execution based on the priority queues' 238 orders. Although discussed herein with respect to placing inference nodes 238 in priority queues 238, it should be understood that what is placed in the queues 238 may actually be references to the inference nodes 238 to run, as well as references to the new/updated data (or other data) to be taken as input by the inference nodes 238, such as data identifiers (IDs) that may be used to retrieve the input data. The worker threads 239 may then retrieve data and code for the inference nodes to run based on such references, and run the retrieved code to process the retrieved data.

Each of the inference nodes 237i is a distinct program representing a subtask of a task that includes multiple such inference nodes. A task may be a procedure and/or a state machine, and a subtask may be a function, a method, and/or a state. A task may be, for example, a sequence of subtasks one after another. For example, a task (e.g., procedure) defined as “((1+2)+3)+4” may include a sequence of subtasks that are defined as “(1+2)=A” then “A+3=B” then “B+4.” Each inference node 237i may further be shared among multiple tasks. For example, a task for processing unusual feature syntax scores received from the neuro-linguistic module 215 may include multiple inference nodes as subtasks, such as anomaly model nodes that determine the unusualness of raw unusual feature syntax scores relative to historically observed scores. In one embodiment, the inference node's code may be stored in short-term memory 227 and retrieved from the short-term memory 227 for execution. It should be understood that the processing of a task, and the execution of inference node subtasks therein, may (or may not) reach a final inference node that publishes a corresponding anomaly special event notification to the user, as discussed in greater detail below.

As shown, each inference node 237i includes trigger criteria, processing logic, and a priority. The trigger criteria specify conditions under which the processing logic is triggered to run. That is, only if a condition matches the trigger criteria is the inference node 237i triggered to run and, in such a case, an inference net scheduler may place the inference node in a priority queue 238i based on the inference node's priority. The priority may be a parameter that is set higher for more important and/or urgent inference nodes, and vice versa. In addition, the inference nodes in the priority queues 238 may be promoted over time to have higher priority so as to ensure that low-priority nodes are eventually passed to the worker threads 239 for execution.

In one embodiment, the inference nodes 237 may be stateless and each have the same type of input and output parameters. During execution of an inference node 237i, the appropriate state, including new and/or updated data that triggered the inference node 237i to run and model(s) associated with the inference node 237i, may be loaded from the short-term memory 227, the semantic memory 230, or longer-term memories, as appropriate. Data identifiers specifying the particular data to load from the short-term memory 227, the semantic memory 230, or longer-term memories may be among the input parameters to the inference node 237i. For example, one of the inference nodes may be responsible for taking as input unusualness scores from the symbolic analysis component 218, the lexical analyzer component 219, or the SXAC component 220, discussed above, and generating percentiles indicating how normal or abnormal the unusualness scores are relative to historically observed scores of the same kind. In such a case, the inference node may load from the short-term memory 227, based on data ID, the input unusualness score and also load a histogram unusual SBAC score model, unusual lexicon score model, or unusual SXAC score model. The inference node may then compare the input unusualness score with the histogram model to determine a percentile of the input unusualness score.

After one of the inference nodes 237 executes, data output by that inference node 237i may be stored in the short-term memory 227. In some embodiments, additional condition(s) are generated from the output data obtained by executing that inference node 237i. The additional conditions are matched to trigger criteria of inference nodes 237 so that the matching inference nodes can be run. This process may repeat, until inferences nodes are reached that do not output data, or data output by the inference nodes that execute do not produce condition(s) that trigger additional inference nodes to run.

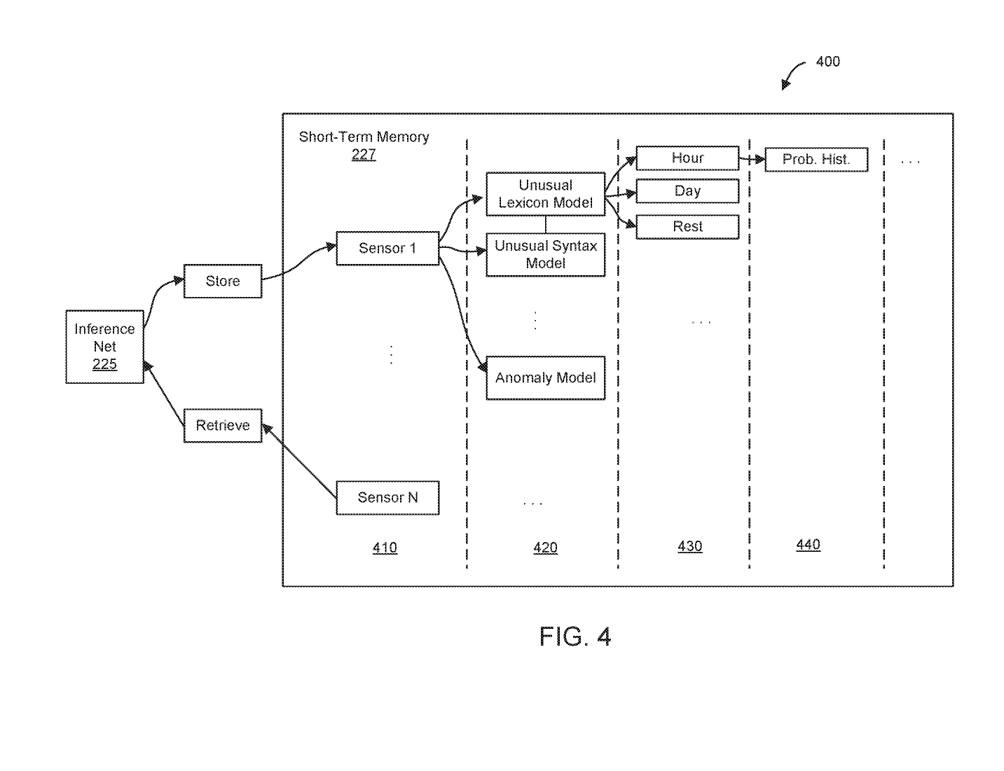

FIG. 4 illustrates components of the short-term memory 227, according to an embodiment. As shown, the short-term memory 227 is a hierarchical key-value datastore which stores new and/or updated data at multiple levels. In one embodiment, the short-term memory 227 may be a hash table which maps keys to values stored in the short-term memory 227 at various levels.

Illustratively, the levels of the short-term memory 227 include a level 410 associated with input source devices (e.g., sensors) that may store sensor state data, a level 420 associated with various unusual models, a level 430 associated with times of the day, and a level 450 in which probability histograms are stored. It should be understood that the models describing what is usual and unusual may generally differ for different times of the day. For example, it may be unusual for a “car” object to be observed at a given location at midnight but not unusual during the daytime. A probability histogram model for each particular time and type of observation (e.g., lexicon, feature syntax, etc.) by each particular sensor may be stored to and retrieved from short-term memory 227. In some embodiments, the short-term memory 227 may include other levels, such as a time-series level storing raw scores (as opposed to histograms) and a jumbo feature level that is at a cross-sensor level.

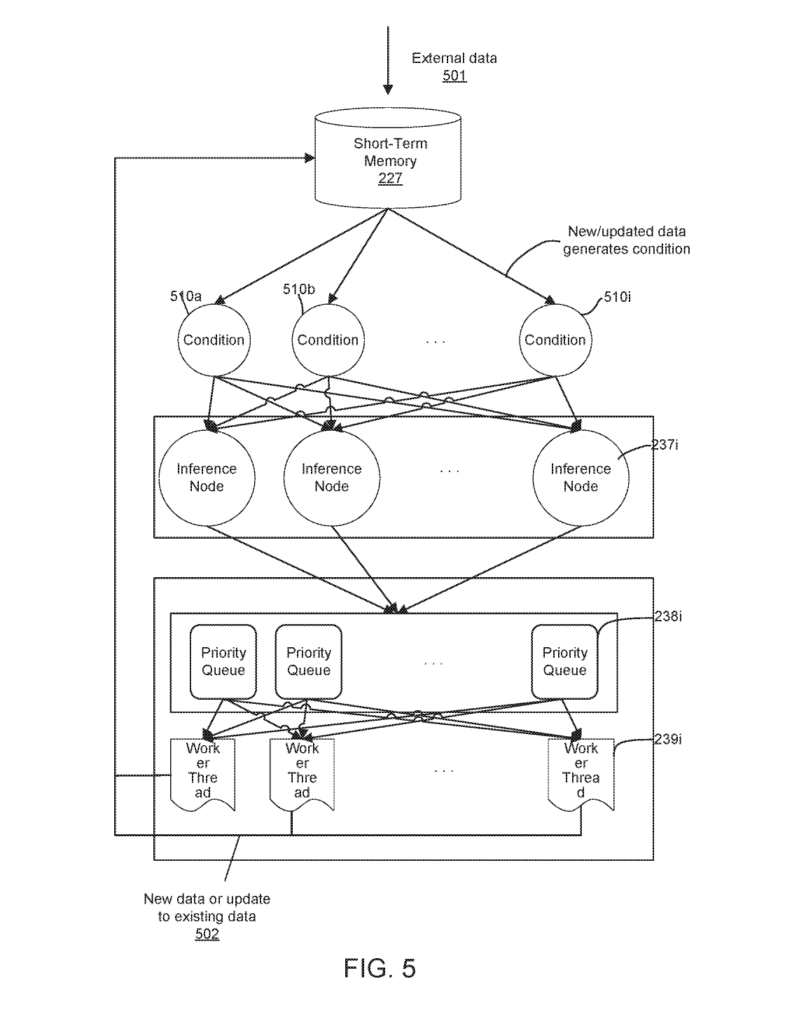

FIG. 5 illustrates an inference network architecture, according to an embodiment. As shown, external data 501 and new and/or updated data (including deletion of data) 502, generated by the worker threads 239 running the inference nodes 237, are stored in short-term memory 227. Responsive to such external data 501 or new/updated data 502 being stored in the short-term memory 227, the short-term memory 227 generates corresponding conditions 510. In one embodiment, each condition for example, 510a, 510b, and 510i (collectively, conditions 510) may specify a data level in the short-term memory 227 and a data ID of the external data 501 or new and/or updated data 502 being stored in the short-term memory 227. As discussed, the short-term memory 227 is a key-value data store, and the data ID in a condition provides the key which may be used to retrieve the external data 501 or new and/or updated data 502.

The inference net scheduler 235 is configured to check the condition(s) 510 generated responsive to new/updated data against each of the inference nodes 237 to determine whether to run the inference nodes 237. As discussed, each of the inference nodes may include trigger criteria, processing logic, and a priority. The trigger criteria specifies conditions under which the processing logic is triggered to process input data. Only if the condition(s) 510 match the trigger criteria of an inference node is that inference node scheduled for execution. In one embodiment, the trigger criteria may include there being sufficient data (of the appropriate type) and resources to perform the processing logic. It should be understood that, by not further processing a task's subtasks (inference nodes) when the criteria for such processing are not met, computational cycles may be saved and worker threads freed to process other subtasks that may be more important. For example, the inference node 237i associated with an unusual lexicon model may include trigger criteria that require as a condition that a raw unusual lexicon score (stored at a particular data level) is above a predefined threshold. In such a case, the unusual lexicon model may not be triggered if the raw unusual lexicon score is below the threshold, indicating that the observation is unlikely to be an anomaly that requires raising a special event notification. As another example, trigger criteria of the inference node 237i may require that a certain amount of data accumulate before processing begins, and if the requisite amount of data is not yet available, the trigger condition would not be met. As yet another example, the trigger criteria for the inference nodes 237i may specify that if the thread pool for running inference nodes has a limited number of threads and there are not enough available threads, then the inference node is not run.

As shown, the inference node scheduler 236 adds inference nodes which match the conditions 510 to one or more priority queues 238 for asynchronous and parallel execution by the worker threads 239. In one embodiment, the inference nodes 237 may be added to the priority queues 238 based on the priority of the inference nodes themselves, discussed above. In addition, the inference node scheduler 236 may increase the priority of subtasks in the priority queues 238 over time as the subtasks remain in the priority queues 238. Doing so helps ensure that the process does not stall, i.e., even low-priority subtasks in the priority queues 238 are eventually passed to the worker threads 239 for execution.

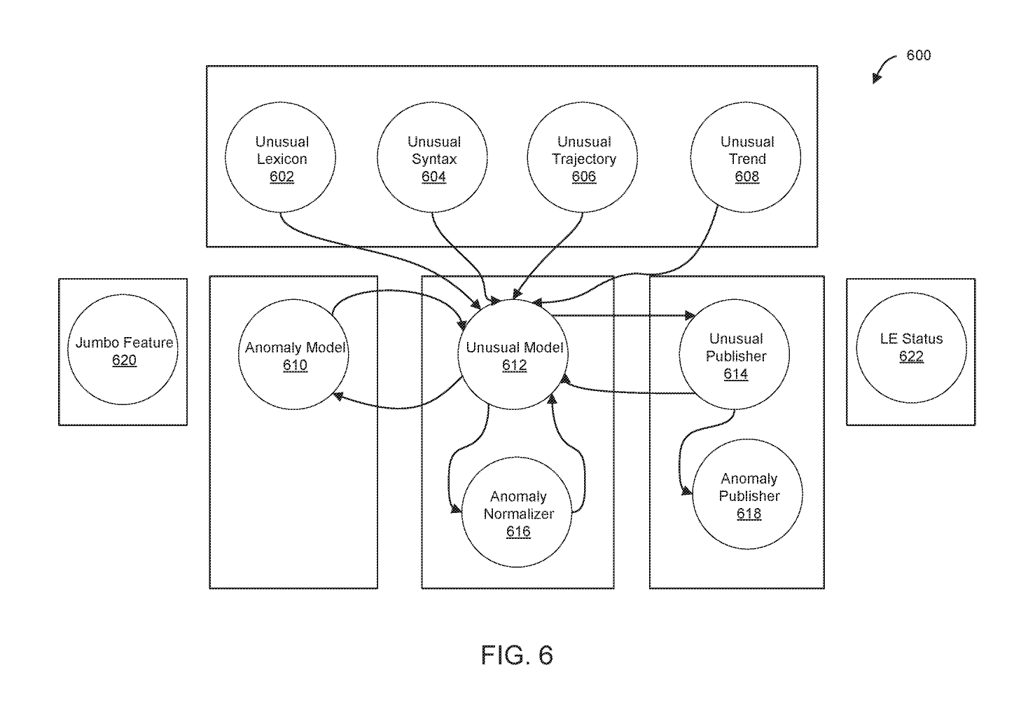

FIG. 6 illustrates example nodes of the inference network 235, according to an embodiment. As shown, the nodes include an unusual lexicon node 602, an unusual feature syntax node 604, and an unusual trajectory node 606, which are configured to compare received unusual lexicon, feature syntax, and trajectory scores, respectively, with corresponding models to determine a normalized percentile indicating how unusual the raw score is as compared to previous unusualness scores for the lexicon, feature syntax, and/or trajectory. In one embodiment, the corresponding models may be histograms that are stored in and retrieved from the short-term memory 227 (or in the semantic memory 230 or longer-term memories). The unusual lexicon node 602, unusual feature syntax node 604, and unusual trajectory node 606 may further update their corresponding models in the short-term memory 227 based on the received scores if the scores reach a statistical confidence threshold.

As shown, the nodes of the inference network 235 further include an unusual model node 612, an anomaly model node 610, and an anomaly normalizer node 616. The normalized percentile of the raw score that is generated by the unusual lexicon node 602, the unusual feature syntax node 604, or the unusual trajectory node 606, may be passed by the unusual model 612 node to the anomaly normalizer node 616 where the percentile may be normalized and then compared to an anomaly model, such as a histogram, constructed from previous normalized percentiles. Based on this second comparison, the anomaly model node 610 may generate a normalized anomaly score indicating, as a percentile, overall unusualness of the score. The anomaly model node 610 and the anomaly normalizer node 616 may further update their corresponding models in the short-term memory 227.

In addition, the nodes of the inference network 235 include an unusual publisher node 614 and an anomaly publisher node 616. The unusual publisher node 614 is configured to determine whether to publish an anomaly special event notification based on the normalized anomaly score output by the anomaly model node 610 exceeds an (adaptive) threshold and other conditions, such as constraints that prevent overburdening special event notification volumes. The anomaly publisher node 616 generates an anomaly special event notification and publishes the special event notification to a user interface so that e.g., the user can investigate the cause(s) of the anomaly.

As shown, the nodes of the inference network 235 also include an unusual trend node 608, a jumbo feature node 620, and an LE status node 622. The unusual trend node 608 is configured to identify long term changes by observing changes in the semantic memory 230 for statistically significant long term changes. As discussed, snapshots of the neuro-linguistic model at different points in time are persisted to the semantic memory 230. The unusual trend node 608 may compare such stored copies of models with current models to detect changes, or simply receive a measure of differences between such models and determine an unusualness of the current models based on how different the current models are from previous models. For example, if the neuro-linguistic model changes drastically over time, this may result in a high unusualness score that is then sent to the anomaly model node 610, the unusual publisher node 614, and the anomaly publisher node 616 for further processing and generating of an special event notification, as appropriate.

The jumbo feature node 620 is configured to learn behaviors of a number of different sensors and relationships between the sensors to determine configurations of features that each of the sensors can contribute to a combined sensor. That is, the combined sensor may be created with features (e.g., location, velocity, acceleration etc. in the case of video data) from two or more other sensors, and the jumbo feature node 620 determines which features from the other sensors should be combined in the single sensor.

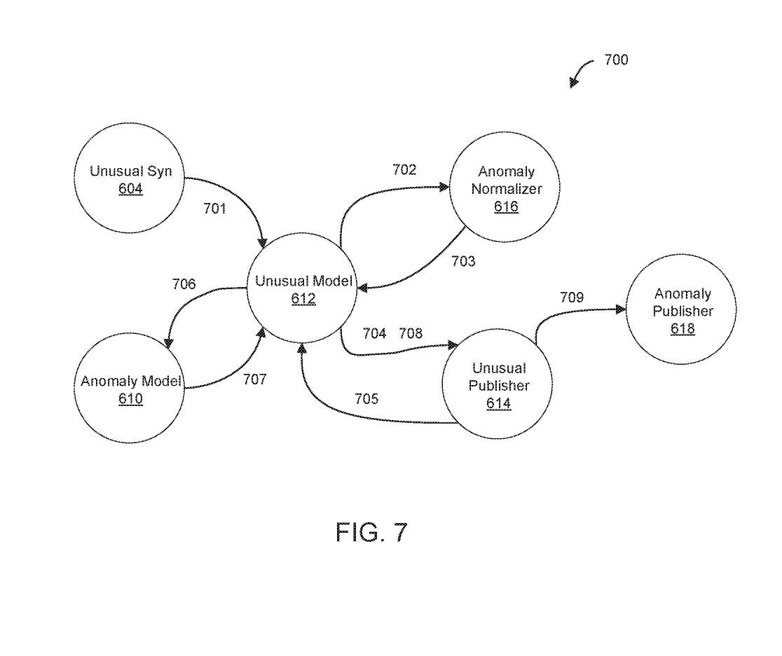

FIG. 7 illustrates an example task 700 in an inference network, according to an embodiment. As shown, the task 700 includes subtasks performed by the unusual feature syntax node 604, the unusual model node 612, the anomaly model node 610, the anomaly normalizer node 616, the unusual publisher node 614, and the anomaly publisher node 618. The example task 700 assumes that the inference net 235 receives an unusual feature syntax score from the SXAC component 220 and processes the unusual feature syntax score using a corresponding task, beginning with the unusual feature syntax node 602.

In one embodiment, a two-stage normalization process may be performed, beginning with a first normalization of the raw unusual feature syntax score to a normalized percentile as against previous unusual feature syntax scores, which may be performed by the unusual feature syntax node 602. A second normalization may be performed after checking with the unusual publisher node 614 triggered at 704, and, in the second normalization, the anomaly normalizer node 416 may generate an anomaly score that is standardized across all of the unusual feature syntax, unusual lexicon, etc. normalizers and that indicates overall unusualness of the observed data generated. In turn, the single anomaly score may trigger the unusual publisher node 614 and the anomaly publisher node 618 to raise a special event notification if, e.g., the single anomaly score exceeds a threshold. As discussed, each of the inference nodes 237 may or may not be triggered to run, depending on whether the condition generated from previous data satisfies that inference node's trigger criteria. In practice, only a small fraction of raw unusual feature syntax scores received from the SXAC component 220 may lead to execution of all inference nodes of the processing task and an special event notification being raised.

While the inference net disclosed herein is directed towards anomaly detection, it should be understood that the methods disclosed herein to generate inference nodes and an inference net can be directed towards performing other tasks too. For example, the inference nodes and hence the inference net can be generated for filtering alerts, etc.

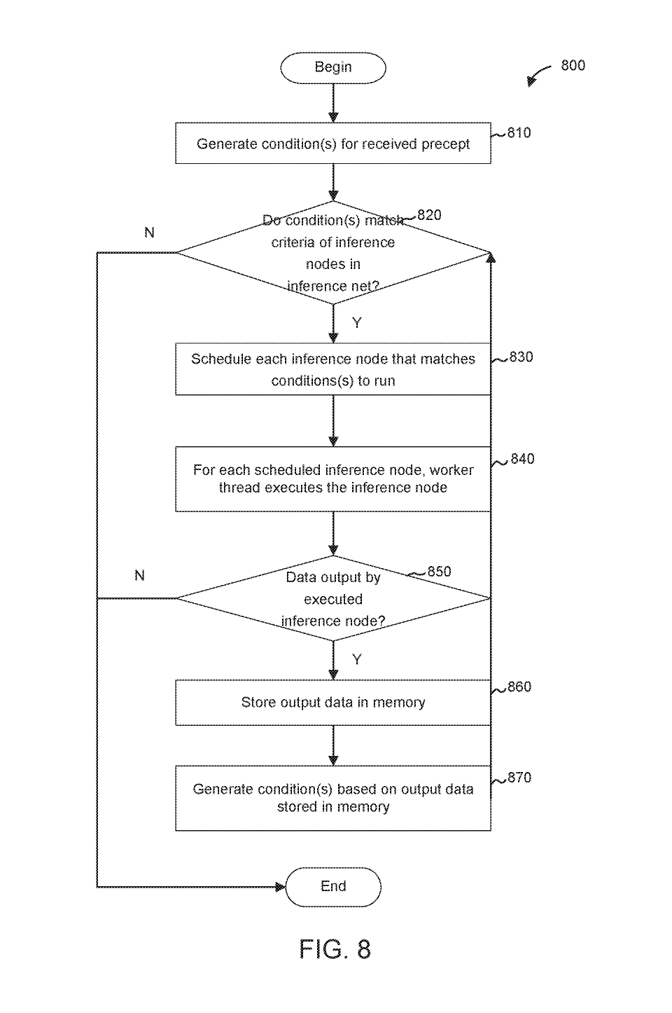

FIG. 8 illustrates a method 800 for processing data in an inference network of a neuro-linguistic cognitive engine, according to an embodiment. As shown, the method 800 begins at step 810, where the short-term memory 227 generates condition(s) in response to a feature syntax being added to short-term memory. As discussed, the short-term memory 227 generates condition(s), which in one embodiment may each specify a data level in the short-term memory 227 and a data ID of the feature syntax being added to the short-term memory 227.

At step 820, the inference net scheduler 236 checks whether the generated conditions match criteria of the inference nodes 237 in the inference net 235. As discussed, each inference node 237i may include trigger criteria, such as there being sufficient data (of the appropriate type) and resources, specifying conditions under which processing logic of the inference node is triggered to run. In a particular embodiment, every feature syntax that is received may trigger at least one inference node to run.

For each of the inference nodes 237 that matches the condition(s), the inference net scheduler 236 schedules the inference node 237i to run at step 830. In one embodiment, the inference net scheduler 236 may add the inference nodes to be executed into one or multiple priority queue(s) 238, based on the priority of each such inference node 237i. The inference net scheduler 236 may also promote lower-priority inference nodes in the priority queues by increasing their priority as those nodes remain in the queues so that the low-priority inference nodes are eventually passed to worker threads for execution.

At step 840, worker threads 239 process the inference nodes in the priority queues 238. In one embodiment, the inference net scheduler 236 passes inference node subtasks from the priority queues 238 to the worker threads 239 for execution in the appropriate order. In another embodiment, multiple worker threads 239 in, e.g., a GPU, may run inference nodes asynchronously and in parallel. Execution of an inference node 237i may result in data being output by the inference node 237i, such as a normalized score or an anomaly score. Of course, the inference node 237i may also not output data, e.g., the anomaly publisher 418 node that is responsible for publishing special event notifications may not output any data for further processing.

If at step 850 it is determined that data has been output by the inference node 237i, then at step 860, the output data is stored in the short-term memory 227 as new or updated data, which may include creating new models in the short-term memory 227 or updating existing models in the short-term memory 227. Additionally, at step 870, the short-term memory 227 generates new condition(s) based on the data output by the inference node 237i and stored in the short-term memory 227. The method 800 then returns to step 820, where the inference net scheduler 236 checks whether the new condition(s) match existing inference nodes' 237 criteria. For example, the normalized score or anomaly score output by an inference node 237i may be the basis for a condition that triggers another inference node 237i to run. Alternatively, the normalized score or anomaly score may not be high enough or may not include the correct type or amount of data, or there may be insufficient resources for another inference node to run, in which the case the method 800 ends. By not performing further processing of a task when the criteria for a subtask is not met, computational cycles are saved and worker threads are freed to process other subtasks (and tasks) that may be more important.

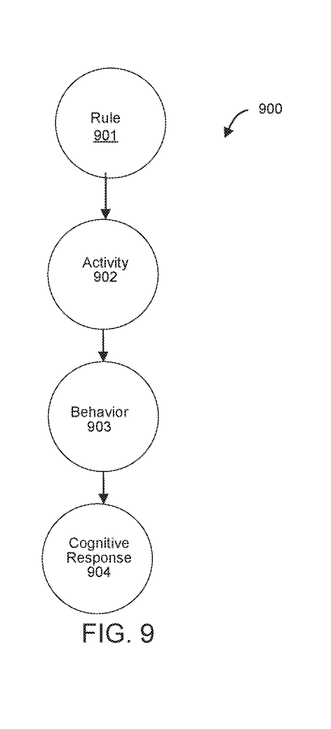

FIG. 9 illustrates a method for cognitive analytics in a neuro-linguistic cognitive engine, according to an embodiment. As shown in FIG. 9, at step 901, a set of rules may be provided to the cognitive engine to define activities, behavior, and/or cognitive responses. At 902, the cognitive engine generates activities based on provided rules. A set of rules make up an activity. At 903, the cognitive engine generates behavior based on the set of activities. For example, the cognitive engine may generate internal representation for activities such as playing basketball, loitering, etc. Based on this set of activities the cognitive engine may generate behavior such as catching the ball, bouncing the ball, throwing the ball, etc. At 904, the cognitive engine generates cognitive responses. The cognitive responses are generated based on the behavior that is generated at step 904 and on the artificial-intelligence-based neuro-linguistic model(s) that is described herein.

Advantageously, techniques disclosed herein may be used to monitor observations from input source devices, for example, sensors such as video surveillance systems, SCADA systems, data network security systems, internet of things (TOT), and the like, and generate special event notifications of anomalous observations. Further, techniques disclosed herein may be used to configure what features to collect from various input source devices providing input to produce a single combined input source device. In addition, technique disclosed herein execute inference nodes in a cognitive engine asynchronously and in parallel, with additional inference nodes being triggered to run only when the nodes' criteria are met, thereby improving computational efficiency and preventing inference nodes from running where the result would not be useful.

While the foregoing is directed to embodiments of the present invention, other and further embodiments of the invention may be devised without departing from the basic scope thereof, and the scope thereof is determined by the claims that follow.

### CONCLUSION

The above-described embodiments can be implemented in any of numerous ways. For example, embodiments may be implemented using hardware, software (e.g., executed or stored in hardware) or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, various above-described concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer-implemented method to implement an adaptive linguistic model for processing data, the method comprising:
generating a representation of at least one condition based on output data generated by the adaptive linguistic model;
determining whether the at least one condition triggers execution of at least one node in a plurality of nodes, each node from the plurality of nodes representing a subtask of at least one task in a plurality of tasks, each task in the plurality of tasks including a plurality of subtasks in an order; and
for each node in the plurality of nodes whose execution is triggered, iteratively performing the following:
executing that node including performing the subtask represented by that node; and
determining if executing that node generates an output;
if executing that node generates an output:
updating the adaptive linguistic model based on the output;
generating at least one additional condition based on the output; and
determining whether the at least one additional condition triggers execution of at least a second node in the plurality of nodes.

2. The method of claim 1, wherein the first node in the plurality of nodes corresponds to the second node in the plurality of nodes.

3. The method of claim 1, wherein the first node differs from the second node.

4. The method of claim 1, wherein executing the first node includes:
loading the adaptive linguistic model from a memory; and
comparing data input into the subtask represented by the first node against the adaptive linguistic model loaded from the memory to determine a score indicating unusualness of the data input into the subtask represented by the first node;

5. The method of claim 4, wherein executing the first node further includes:
retrieving the data input into the subtask represented by the first node from the memory; and
storing the score in the memory,
the at least one additional condition being generated responsive to the storing of the score in the memory.

6. The method of claim 4, wherein the adaptive linguistic model is a first adaptive linguistic model, the memory is at least one of:
a first memory configured to store a second adaptive linguistic model, the second adaptive linguistic model being an updated version of the first adaptive linguistic model or
a second memory configured to store a third adaptive linguistic model, the third adaptive linguistic model being the first adaptive linguistic model that has reached a statistical significance threshold.

7. The method of claim 6, wherein:
the first memory includes a hierarchical data structure mapping keys to values, and
the second memory is an episodic memory that includes a sparse distributed memory.

8. The method of claim 6, wherein the adaptive linguistic model attaining statistical confidence threshold from the second memory is further persisted in a third memory that stores generalizations and representations of data with episodic details removed.

9. The method of claim 4, wherein the adaptive linguistic model is at least one of:
a model used to identify feature symbols, feature words and feature syntax from data;
a model used to determine anomalies;
a model used to determine unusual lexicon;
a model used to determine unusual feature syntax;
a model used to determine unusual trajectories; or
a model used to determine unusual trends over time.

10. The method of claim 1, further comprising:
responsive to determining that the at least one condition or the at least one additional condition triggers execution of at least one node from the plurality of nodes, placing the subtask represented by the at least one node in a priority queue for execution,
a priority of subtasks in the priority queue being increased over time as the subtasks remain in the priority queue.

11. The method of claim 1, wherein the at least one condition and the at least one additional condition include a requirement for sufficient data and resources for computation of subtasks.

12. The method of claim 1, wherein executing at least two nodes in the plurality of nodes includes performing the corresponding subtasks representing the at least two nodes asynchronously and in parallel.

13. The method of claim 1, wherein the plurality of tasks include a task configured to determine configurations of features that each sensor of a plurality of sensors can contribute to a single combined sensor based on learned behaviors of and relationships between the plurality of sensors.

14. The method of claim 1, wherein each task in the plurality of tasks represents at least one of anomaly detection or filtering alerts.

15. The method of claim 1, wherein the plurality of nodes are configurable and programmable.

16. A non-transitory computer-readable storage medium storing instructions, which when executed by a computer system, perform operations for processing data, the operations comprising:
generating a representation of at least one condition based on output data generated by an adaptive linguistic model;
determining whether the at least one condition triggers execution of at least one node in a plurality of nodes, each node from the plurality of nodes representing a subtask of at least one task in a plurality of tasks, each task in the plurality of tasks including a plurality of subtasks in an order; and
for each node in the plurality of nodes whose execution is triggered, iteratively performing the following:
executing that node including performing the subtask represented by that node, and
if the subtask for that node produces an output:
generating at least one additional condition based on the output of the subtask for that node; and
determining whether the at least one additional condition triggers execution of at least another node in the plurality of nodes.

17. The computer-readable storage medium of claim 16, wherein executing the first node includes:
loading the adaptive linguistic model from a memory; and
comparing data input into the subtask represented by the first node against the adaptive linguistic model loaded from the memory to determine a score indicating unusualness of the data input into the subtask represented by the first node;

18. The computer-readable storage medium of claim 17, wherein executing the first node further includes:
retrieving the data input into the subtask represented by the first node from the memory; and
storing the score in the memory,
the at least one additional condition being generated responsive to the storing of the score in the memory.

19. The computer-readable storage medium of claim 17, wherein the adaptive linguistic model is a first adaptive linguistic model, the memory is at least one of:
a first memory configured to store a second adaptive linguistic model, the second adaptive linguistic model being an updated version of the first adaptive linguistic model or
a second memory configured to store a third adaptive linguistic model, the third adaptive linguistic model being the first adaptive linguistic model that has reached a statistical significance threshold.

20. The computer-readable storage medium of claim 19, wherein:
the first memory includes a hierarchical data structure mapping keys to values, and
the second memory is an episodic memory that includes a sparse distributed memory.

21. The method of claim 17, wherein the adaptive linguistic model is at least one of:
a model used to identify feature symbols, feature words, and feature syntax from data;
a model used to determine anomalies;
a model used to determine unusual lexicon;
a model used to determine unusual feature syntax;
a model used to determine unusual trajectories; or
a model used to determine unusual trends over time.

22. The computer-readable storage medium of claim 16, the operations further comprising:
responsive to determining that the at least one condition or the at least one additional condition triggers at least one node from the plurality of nodes, placing the subtask represented by the at least one node in a priority queue for execution, a priority of subtasks in the priority queue being increased over time as the subtasks remain in the priority queue.

23. The computer-readable storage medium of claim 16, wherein the at least one condition and the at least one additional condition include a requirement for sufficient data and resources for computation of subtasks.

24. A system, comprising:
a processor;
and a memory including an application program configured to perform operations for processing data, the operations comprising:
generating a representation of at least one condition based on output data generated by an adaptive linguistic model;
determining whether the at least condition triggers execution of at least one node in a plurality of node, each node from the plurality of node representing a subtask of at least one task in a plurality of tasks, each task in the plurality of tasks including a plurality of subtasks in an order; and
for each node in the plurality of nodes whose execution is triggered, iteratively performing the following:
executing that node including performing the subtask represented by that node; and
if the subtask for that node produces an output:
generating at least one additional condition based on the output of that subtask, and
determining whether the at least one additional condition triggers
execution of at least another node in the plurality of nodes.
